(19) United States
(12) Patent Application Publication
(10) Pub. No.: US 2023/0155681 A1
(43) Pub. Date: May 18, 2023

(54) Metric for Determining if a Multimode Optical Fiber is Dispersion Compensating

(71) Applicant: Panduit Corp., Tinley Park, IL (US)

(72) Inventors: Richard J. Pimpinella, Prairieville, LA (US); Jose M. Castro, Naperville, IL (US)

(73) Assignee: Panduit Corp., Tinley Park, IL (US)

(21) Appl. No.: 17/987,368

(22) Filed: Nov. 15, 2022

Related U.S. Application Data
(60) Provisional application No. 63/279,739, filed on Nov. 16, 2021.

(51) Int. Cl. H04B 10/2525; G01M 11/00; H04B 10/2581

(52) U.S. Cl. CPC H04B 10/2525; G01M 11/30; H04B 10/2581

(57) ABSTRACT

A method for determining if a graded-index glass optical multimode fiber has a refractive index profile that will compensate modal dispersion with chromatic dispersion when used in an optical channel having a multimode vertical cavity surface emitting laser has at least two weighting functions. The functions are used to compute the relative mode group delays over two radial offset regions within the core of the optical fiber. The peak group delay of the of the higher-order fiber mode distribution is less than the peak group delay of the lower-order mode distribution.

### CROSS REFERENCE TO RELATED APPLICATION

This application claims benefit to U.S. Provisional Patent Application No. 63/279,739, filed Nov. 16, 2021, the entirety of which is hereby incorporated by reference herein.

### FIELD OF INVENTION

The present invention relates to the field of multimode optical fiber (MMF) used for optical data communications. The disclosed invention describes an improved method for identifying a laser optimized multimode optical fiber that will compensate modal dispersion with chromatic dispersion when the fiber is used in conjunction with vertical cavity surface emitting lasers (VCSELs). An optical fiber according to the disclosed invention will reduce the total dispersion of the communication channel as the signal propagates through the fiber, thereby increasing the optical channel bandwidth compared to non-compensating MMF.

### BACKGROUND

It was generally assumed during the development of 10 Gb/s Ethernet, the design of Laser Optimized Glass optical fiber, and the development of VCSELs in the late 1990s and early 2000s, that the spectral emission pattern of the VCSEL was homogeneous. It was assumed the output spectrum of the VCSEL was uniformly distributed over the full angular range of its numerical aperture. In 2008, the author of this disclosure discovered that higher-order modes of the VCSEL spectrum 104 consisted of the shorter wavelength and were emitted into larger angles, whereas the lower order VCSEL modes 103 consisted of the longer wavelengths and were emitted into shallow angles, FIG. 1. Consequently, shorter VCSEL wavelengths couple into higher-order fiber modes 106 and the longer wavelengths 104 couple into the lower-order fiber modes 105. As a result, industry Standard test methods for measuring the differential mode delay (DMD), neglected to account for the chromatic dispersion of the VCSELs radial dependent wavelength emission pattern 102. It was further discovered by the author of this disclosure that due to chromatic dispersion of the radial mode group delays 201, the channel DMD is altered as illustrated in 202, FIG. 2, and hence, the fiber's Effective Modal Bandwidth (EMB) will not correlate to the VCSEL-Fiber channel's bit error rate (BER) performance. It was realized that by selecting MMFs where the pulse delays of the higher-order fiber modes were shorter than the pulse delays of the lower-order modes as determined by DMD measurements, one can compensate modal dispersion with chromatic dispersion of the propagating wavelengths in order to reduce the total dispersion of VCSEL-Fiber channel. In other words, since shorter wavelengths travel slower in glass media than longer wavelengths, it is possible the select fibers where the group delay of the higher-order fiber modes as measured by the Standards specified DMD test wavelength of 850 nm are shorter than low order fiber modal delays, in this way, the slower group velocity of the shorter wavelengths will offset the shorter DMD pulse delay. Hence, an optical fiber according to the present invention, will compensate modal dispersion with chromatic dispersion of the propagating VCSEL wavelengths and will significantly reduce the total channel dispersion, increasing the optical channel bandwidth performance.

In this disclosure we describe an improved method for selecting dispersion compensating MMF, which provides additional information regarding the channel performance when the fiber and VCSEL form the optical channel.

### SUMMARY

A method for determining if a graded-index glass optical multimode fiber has a refractive index profile that will compensate modal dispersion with chromatic dispersion when used in an optical channel having a multimode vertical cavity surface emitting laser has at least two weighting functions. The functions are used to compute the relative mode group delays over two radial offset regions within the core of the optical fiber. The peak group delay of the of the higher-order fiber mode distribution is less than the peak group delay of the lower-order mode distribution.

### BRIEF DESCRIPTION OF THE DRAWINGS

FIG. 1 shows that higher-order modes of the VCSEL spectrum 104 consisted of the shorter wavelength and were emitted into larger angles, whereas the lower order VCSEL modes 103 consisted of the longer wavelengths and were emitted into shallow angles.

FIG. 2 shows that due to chromatic dispersion of the radial mode group delays 201, the channel DMD is altered as illustrated in 202.

FIG. 3 shows a simple method for selecting dispersion compensating MMF by comparing the DMD peak pulse delays at various radial waveform offsets to sort for dispersion compensating MMF.

FIG. 4 shows the DMD Standard defined 10 weighting functions 401 representing the radial power distribution of 10 representative VCSELs.

FIG. 5 shows a DMD plot 500 of an OM4 multimode mode fiber.

FIG. 6 shows an exemplary scenario in which two weighting functions 1 and 5 are selected and specified in the DMD measurement Standard, 601 and 602, respectively.

FIG. 7(a) shows a plot of the weighted DMD resulting from the representative VCSEL radial power distribution 1.

FIG. 7(b) shows a plot of the weighted DMD resulting from the representative VCSEL radial power distribution 5.

FIG. 8 shows the weighted shift with two weighting functions 1 and 5 801 and 802, respectively.

FIG. 9 shows a second exemplary scenario with bimodal weight function 8 specified in the DMD measurement Standard, 901.

FIG. 10(a) shows the weighted DMDs resulting from the one representative VCSEL radial power distribution (TIA weight 8).

FIG. 10(b) shows the temporal delay between the peak 920, and centroid 921 values of the weighted DMD can be used to estimate the high and low order modal delays.

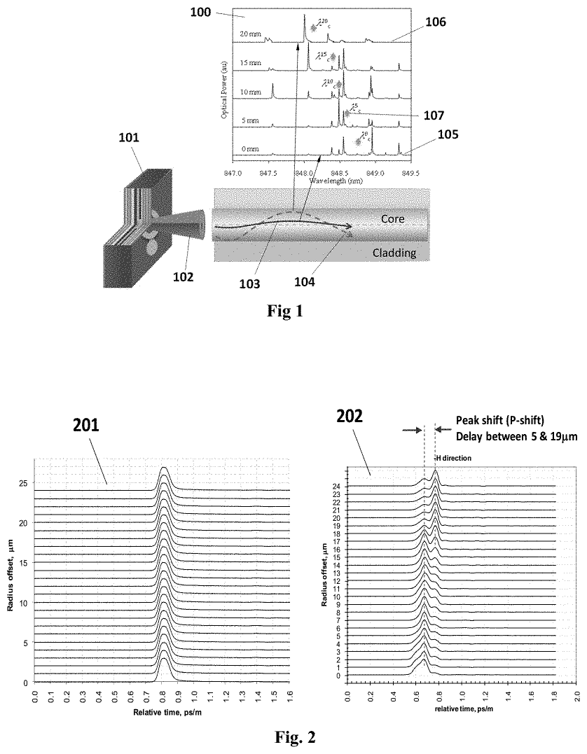

### DESCRIPTION OF THE INVENTION

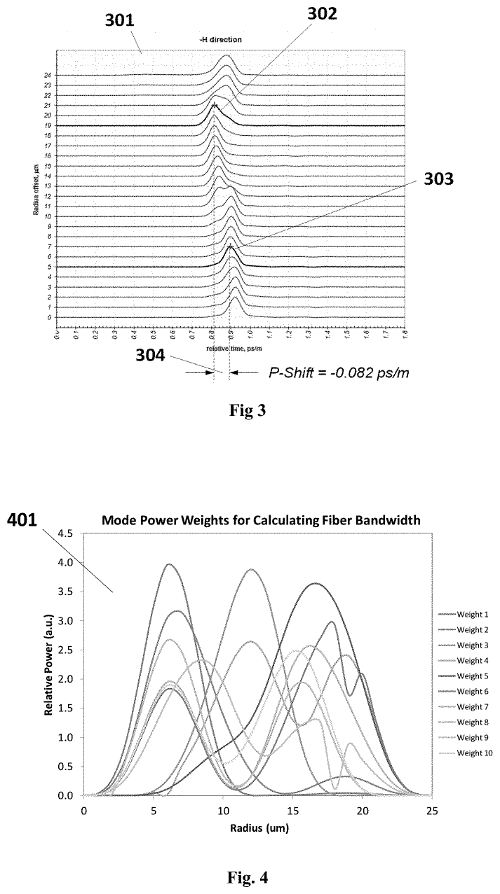

Previous disclosures by the author of this invention describe a simple method for selecting dispersion compensating MMF by comparing the DMD peak pulse delays at various radial waveform offsets to sort for dispersion compensating MMF, FIG. 3. The method entails measuring the DMD radial pulse waveforms 301, and select for comparison the peak amplitudes between two radial offsets, where the higher-order mode group 302, having a 19 μm radial offset is compared to a lower-order mode group 303 having a 5 μm radial offset. In this example, we illustrate the two radial offsets of 19 μm and 5 μm, however, other radial offsets can be selected. The radial waveform peak amplitude delay at the 19 μm radial offset in the DMD measurement profile must be less than the waveform peak amplitude delay at 5 μm radial offset in order to compensate for chromatic dispersion. The difference in peak amplitude delays were defined in the previous method as the “P-Shift” metric and is calculated using,

$$P - Shift ( ps / m ) = \frac{19 µm delay ( ps ) - 5 µm delay ( ps )}{Fiber Length ( m )}$$

specified in units of ps/m.

The improved method according to the present invention is to utilize weighting functions such as those used in the DMD measurement Standard for calculating the Effective Modal Bandwidth (EMB). The DMD Standard defines 10 weighting functions 401 representing the radial power distribution of 10 representative VCSELs, FIG. 4. The weighting functions are utilized to calculate 10 possible EMBs for each of the representative VCSELs. Note, the weighting functions represent the power distribution covering the statistical variation of manufactured VCSELs, and do not include any wavelength dependence. The effective modal bandwidth is calculated for each of the VCSEL weighting functions and the worst-case i.e., minimum calculated bandwidth, referred to as minEMBc, is the value used to specify the fiber's EMB, where EMB=1.13×minEMBc.

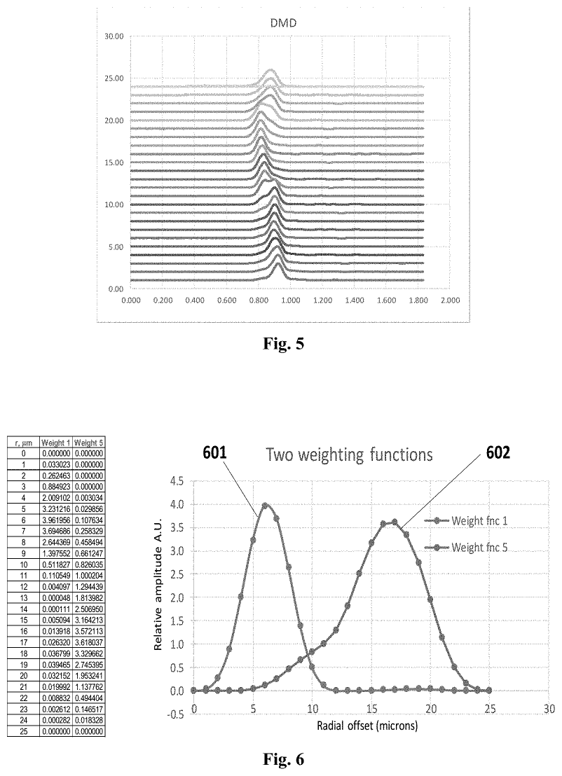

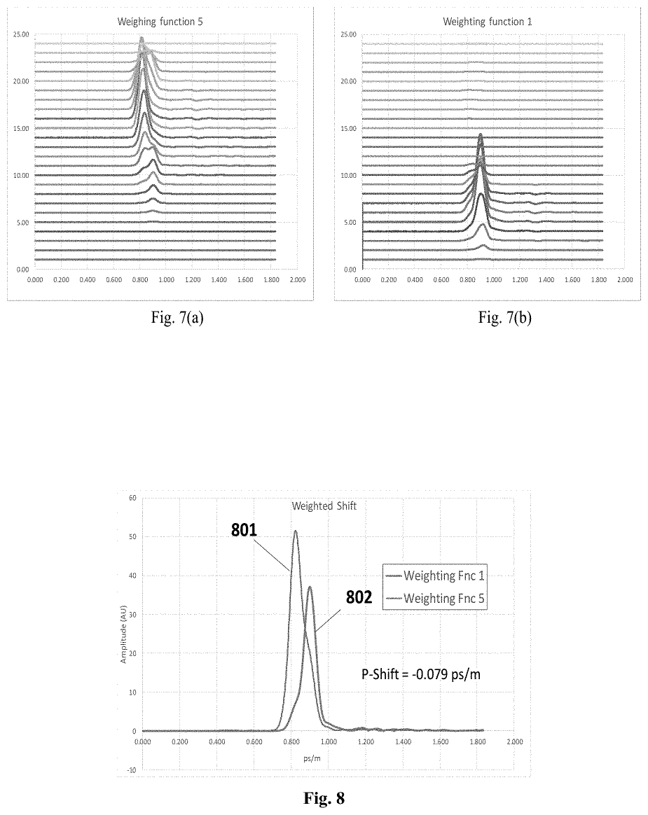

Unlike the previously disclosed method of comparing the relative shift in peak amplitudes between two discrete radial pulse waveforms (P-Shift), here we compare two resultant weight DMD profiles computed from two weighting functions. As an example of the improved method, consider the DMD plot 500 of an OM4 multimode mode fiber shown in FIG. 5. In this exemplary scenario, we select two weighting functions 1 and 5 specified in the DMD measurement Standard, 601 and 602 respectively, FIG. 6. In FIGS. 7(a) & 7(b), we plot the weighted DMDs resulting from the two representative VCSEL radial power distribution 1 and 5 respectively. Utilizing the improved method according to the present invention, we compare the resultant radial mode group delays over two ranges of the DMD profile. By utilizing the Standards specified weighting functions, the new metric can easily be included in the computation of minEMBc. Hence, in this scenario, if we compare the relative delay in peak amplitudes of the two resultant waveforms, 801 and 802, the resultant delay is found to be −0.082 ps/m, compared to −0.079 ps/m as determined from the previous P-Shift metric.

Alternatively, only one weight function can be used to estimate the modal-chromatic dispersion compensation properties. One can use the weighting distribution from the standard DMD test method, or mathematically produced a general distribution given by,

F(r)=G(r)+H(r−R) (1)

Where H(r) and G(r) are positive, e.g., Gaussian distributions, r is the radial offset, and R is a fixed radial offset. Eq. (1) allows one to produce positive functions with unimodal or bimodal shapes that can be designed to represent at least all the VCSEL weights used in the DMD measurement standard 601 and 602 or other weights that can be related to new VCSEL production, e.g., new VCSELs designed for 100 Gb/s transmission per wavelength.

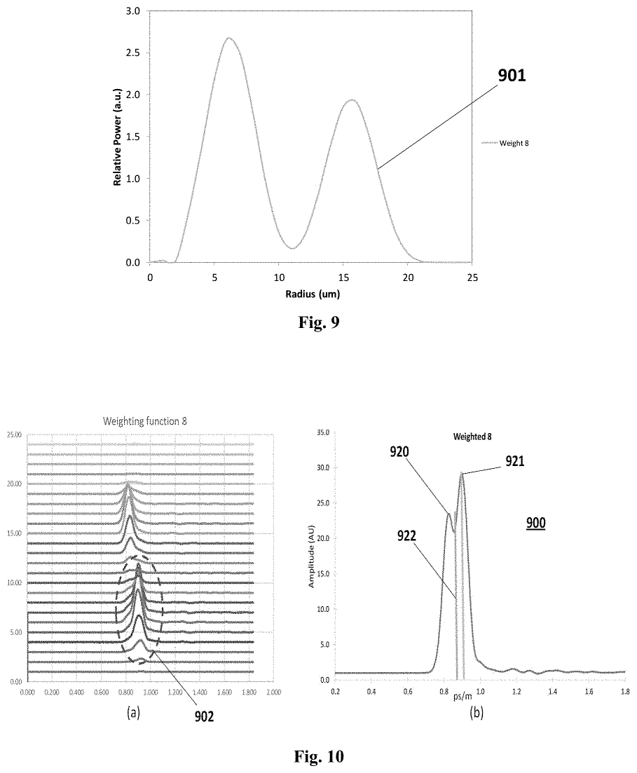

In general, equation (1) can be applied to the measured DMD pulse waveforms and the degree of skew of the resultant waveforms can be used to estimate the delay between high and low order modes. For illustrative purposes in this second exemplary scenario, we select bimodal weight function 8 specified in the DMD measurement Standard, 901, FIG. 9. The weighted DMDs resulting from the one representative VCSEL radial power distribution (TIA weight 8) is shown in FIG. 10(a). Close inspection of the bimodal distribution 901, reveals that the lower radii region will be more heavily weighted than the higher radii region due to the difference in amplitudes. However, the amplitudes are close enough to characterize the skew in the radial mode groups. Utilizing this bimodal weight, the temporal delay between the peak 920, and centroid 921 values of the weighted DMD can be used to estimate the high and low order modal delays.

Alternatively, other measures can be used to compare the relative delay between low-order and high-order mode groups such as the resultant waveform 900 centroids, or other representative parameter. If the measured delay of the higher-order modes is less than the lower-order modes, the fiber has modal-dispersion compensating properties.

The new methods and metrics according to the present invention provides additional information that can be used to improve the dispersion compensation analysis. For example, the improved metric provides resultant pulse width and amplitude data that can be used to support additional analysis.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for determining if a graded-index glass optical multimode fiber has a refractive index profile that will compensate modal dispersion with chromatic dispersion when used in an optical channel having a multimode vertical cavity surface emitting laser, where;
at least two weighting functions are used to compute the relative mode group delays over two radial offset regions within the core of the optical fiber, and where,
the peak group delay of the of the higher-order fiber mode distribution is less than the peak group delay of the lower-order mode distribution.

2. A method according to claim 1, where the centroids of the lower and higher order mode group distributions are used to compare the relative difference in radial mode group distributions.

3. A method according to claim 1, where the averages of the two said distributions are used to determine the relative delays between the higher-order and lower-order mode group delays.

4. A method according to claim 1, where the weighting function are specified in the industry Standards test method TIA xxx

5. A method for determining if a graded-index glass optical multimode fiber has a refractive index profile that will compensate modal dispersion with chromatic dispersion when used in an optical channel having a multimode vertical cavity surface emitting laser, where;
a bimodal weighting function is used to characterize the mode group delays of both the low and high order fiber modes, and where,
the peak group delay of the high-order mode group distribution is faster than the centroid group delay the power radial distribution.

6. A method according to claim 5, where the centroids of the lower and higher order mode group distributions are used to compare the relative difference in radial mode group distributions, and where,
the propagation delay of the centroid of the higher-order mode group distribution is less that the delay of the centroid of the lower-order mode group distribution.
